(19) United States
(12) Patent Application Publication
(10) Pub. No.: US 2023/0274377 A1
(43) Pub. Date: Aug. 31, 2023

(54) AN END-TO-END PROCTORING SYSTEM AND METHOD FOR CONDUCTING A SECURE ONLINE EXAMINATION

(71) Applicant: Extramarks Education India Pvt Ltd., Noida, Uttar Pradesh (IN)

(72) Inventors: Ritvik Kulshrestha, Noida, Uttar Pradesh (IN); Tanay Karve, Noida, Uttar Pradesh (IN); Deep Dwivedi, Noida, Uttar Pradesh (IN); Abhra Das, Noida, Uttar Pradesh (IN); Suman Gadhawai, Noida, Uttar Pradesh (IN); Vipin Tripathi, Noida, Uttar Pradesh (IN); Gaurav Sharma, Noida, Uttar Pradesh (IN)

(21) Appl. No.: 17/623,230

(22) PCT Filed: Dec. 13, 2021
(86) PCT No.: PCT/IB2021/061609

§ 371 Date: Dec. 27, 2021

(51) Int. Cl. G06Q 50/20; H04L 9/40

(52) U.S. Cl. CPC G06Q 50/205; H04L 63/0861

(57) ABSTRACT

The present disclosure provides an end-to-end proctoring system and method for conducting a secure online examination. The system comprises an image capturing device and an audio recording device for capturing and recording a plurality of live face images and a plurality of audio files of one or more users respectively. A processor is programmed to execute one or more module(s) stored in a memory, including, but not limited to, a user face recognition module, an occlusion detection module, a user authentication module, an object detection module, and an audio analytics module. The processor is further configured to control a warning module that may output a notification signal for the one or more module(s) when at least one suspicious activity is determined during the secure online examination. Further, the system with the processor for executing the one or more module(s) is pre-trained on various deep learning-based approaches for conducting a secure online examination.

### TECHNICAL FIELD OF THE DISCLOSURE

The present disclosure relates to an end-to-end proctoring system and method based on Convolutional Neural Network (CNN) for conducting a secure online examination.

### BACKGROUND

Online education has become a common practice and it has replaced a large percentage of traditional classroom education. With the advent of online examinations, it is impracticable to personally monitor each student taking an online examination. The process of manual invigilation in an online examination can be a hectic task for an invigilator. Further, the manual invigilation process cannot prevent cheating in an online setting and there is a high possibility that students might indulge themselves in malpractice activities. They might take help from objects such as mobile phones, books, additional handheld devices that may display content such as touch pads etc. while taking the online examination. In addition, the student might involve other persons present in their surroundings during the examination, to assist them with the examination. The human invigilator cannot identify multiple persons and speakers present in the online examination and therefore cannot detect the cheating behavior of the students accurately. Also, an online proctor can monitor multiple webcams feeds, but it cannot monitor the multiple audio feeds coming in from different users at the same time, hence cannot accurately identify which student is engaged in malpractice activity.

There exists several technologies that prevent students from opening apps or web browsers during online examinations, however, still many practices like verifying the identity of the examinees must be done manually, which is a cumbersome task. Additionally, some examination institutes employ services with live exam proctors who can monitor students taking an examination remotely over webcams. A few institutes are also hiring companies that provide online proctoring during examinations. The online proctoring solutions can detect suspicious activities; however, the invigilator needs to keep an eye on the screen due to the absence of few important features in the software such as obstruction detection and speaker identification. Moreover, the identification of suspicious objects such as mobile phones, books, etc. is a challenging task in an uncontrolled proctoring environment. Many institutions have tried to overcome these shortcomings of online systems by reducing the workload on the students, however, the need for technology to create a fair and proper operational exam environment for students is still present.

Further, the identification and segregation of several distinct speakers present during the online examination requires automatic speech processing systems that can separate segments from different speakers. However, existing work fails to utilise techniques such as speaker diarisation that can create various clusters of the audio files and can identify the number of distinct speakers present during an online examination. Therefore, there exists a need for online proctoring systems and related methods that may overcome the shortcomings of the prior art by enabling an automatic proctoring system for online examinations to monitor students taking an examination, which might reduce the risk of students indulging themselves in malpractice activities while taking an online examination and might result in a secure online examination environment.

### SUMMARY

The present disclosure aims at solving the problems described above.

The present disclosure discloses an end-to-end proctoring system and method based on Convolutional Neural Network (hereinafter CNN) for conducting a secure online examination. The system may include an image capturing device for capturing a plurality of live face images and an audio recording device for recording a plurality of audio files of one or more users. Further, the system may include a processor with a memory for executing one or more module(s) including, but not limited to, a user face recognition module, an occlusion detection module, a user authentication module, and an audio analytics module. Additionally, the system may include an object detection module executed by the processor. The processor may receive the plurality of live face images and the audio files of the one or more users from an input module for recognising the plurality of live face images and the audio files. The processor may be further configured to control a warning module present inside an output module. The warning module may serve as a repository for storing data processed and generated by the one or more module(s) stored in the memory. The warning module may output a notification signal for the one or more module(s) to the one or more users and an administrator indicating that at least one suspicious activity is determined during the secure online examination.

In an embodiment, the present disclosure relates to an end-to-end proctoring method based on CNN for conducting the secure online examination. The method may include a processor for executing one or more module(s) including, but not limited to, a user face recognition module, an occlusion detection module, a user authentication module, and an audio analytics module stored in a memory. Further, the user face recognition module may be configured to dynamically track and notify a count of faces present in the plurality of live face images of the one or more users captured by the image capturing device. The occlusion detection module may be configured to spot and notify a plurality of blockages to the plurality of live face images of the one or more user’s face when the face count is tracked by the user face recognition module. Further, the user face authentication module may be configured to match and notify at a pre-defined interval whether the plurality of live face images of the one or more users matches with pre-stored facial feature information of the one or more users when a non-occluded live face image of at least one user is spotted by the occlusion detection module. The audio analytics module may be configured to capture and notify a count of distinct voices, silence, and noise present in a plurality of audio files of the one or more users recorded by the audio recording device. The plurality of audio files may be captured by the audio analytics module based on frequency, pitch, and tone characteristics of the one or more users. Additionally, an object detection module may be configured to locate and notify a plurality of suspicious objects present in the plurality of live face images of the one or more users.

In another embodiment, the processor with the memory may provide the warning module configured to output a notification signal for the one or more module(s) to the one or more users and an administrator, the notification signal indicating that at least one suspicious activity is determined during the secure online examination. Further, the system with the processor for executing the one or more module(s) may be pre-trained based on various deep learning approaches, configured to determine the at least one suspicious activity during the secure online examination. The training of the end-to-end proctoring system using various deep learning approaches may offer improved accuracy, create, and enhance online proctoring services and may provide an efficient way of organizing examinations to institutions.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings are incorporated herein and form a part of the disclosure.

FIG. 1 depicts an end-to-end proctoring system for conducting a secure online examination.

FIG. 2 illustrates a flowchart of an end-to-end proctoring method for conducting a secure online examination.

FIG. 3 depicts a user face recognition module utilised for tracking and notifying at least one suspicious activity during a secure online examination.

FIG. 4 depicts an occlusion detection module utilised for spotting and notifying at least one suspicious activity during a secure online examination.

FIG. 5 depicts a user face authentication module utilised for matching and notifying at least one suspicious activity during a secure online examination.

FIG. 6 depicts an object detection module utilised for locating and notifying at least one suspicious activity during a secure online examination.

FIG. 7 depicts a process flow diagram of an embodiment to implement the method of capturing and notifying by an audio analytics module at least one suspicious activity during a secure online examination.

FIG. 8 illustrates an exemplary block diagram of a computer system for implementing embodiments consistent with the present disclosure.

### DETAILED DESCRIPTION OF THE DRAWINGS

While the disclosure has been disclosed with reference to certain embodiments, it will be understood by those skilled in the art that various changes may be made, and equivalents may be substituted without departing from the scope of the disclosure. In addition, many modifications may be made to adapt to a particular situation or material to the teachings of the disclosure without departing from its scope.

Throughout the disclosure and claims, the following terms take the meanings explicitly associated herein unless the context clearly dictates otherwise. The meaning of “a”, “an”, and “the” include plural references. The meaning of “in” includes “in” and “on”. Referring to the drawings, as numbers indicate like parts throughout the views. Additionally, a reference to the singular includes a reference to the plural unless otherwise stated or inconsistent with the disclosure herein.

The term “image” shall mean any type of digital data, which has a two-dimensional or three-dimensional representation. An image can be created by a camera, or a webcam, to capture the image of one or more users on a display of certain electronic devices.

The term “audio” shall mean any type of voice including background or environmental voices. An audio can be created by a microphone, or a recorder, to record the audio of one or more users.

The term “Artificial Intelligence” (AI) refers to a technology that may simulate human intelligence in machines (computers). AI may utilise Machine Learning (ML) algorithms to detect, align, extract, and recognise the face and audio characteristics of the one or more users in the plurality of live face images and the audio files respectively. AIs are the subset of machine-learning methods and may be utilised to execute one or more operations during the process of face recognition and audio identification according to the embodiments of the disclosure.

The term “Convolution Neural Network” (CNN) refers to a deep learning algorithm that may be used to extract the face and audio characteristics of the one or more users in the plurality of live face images and the audio files respectively. CNN’s are a branch of machine-learning methods and may be utilised to execute one or more operations during the process of face recognition and audio identification according to the embodiments of the disclosure. In this disclosure, the term “Convolutional Neural Network” may refer to a pre-trained neural network or neural network that is to be trained.

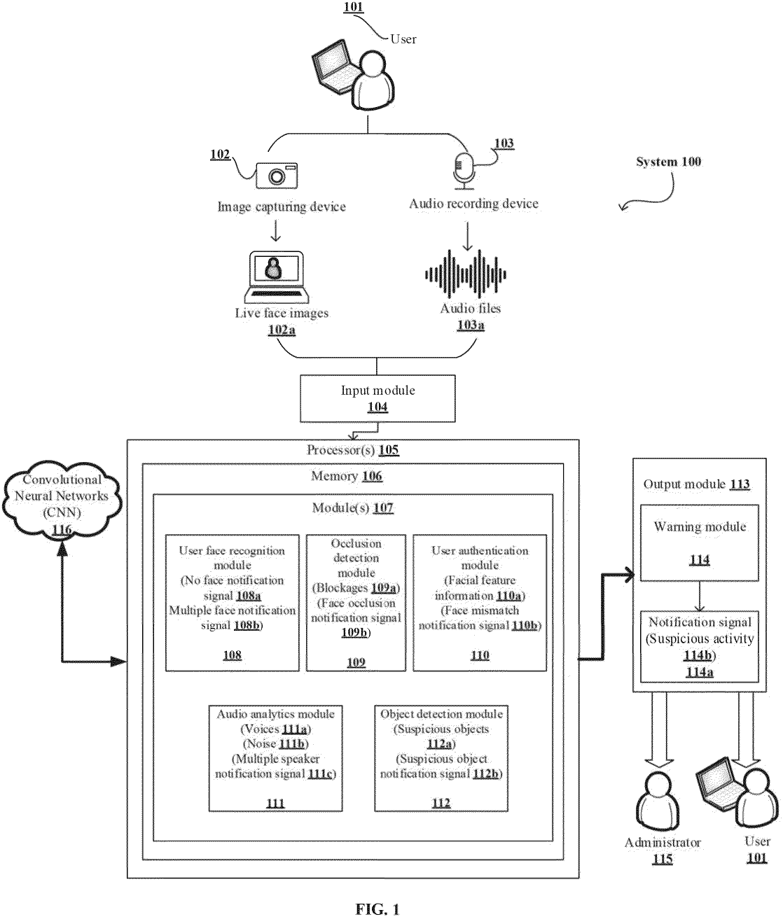

Various embodiments of these features will now be discussed with respect to the corresponding FIGS. 1-8.

FIG. 1 illustrates an end-to-end proctoring system 100 enabling and/or providing implementation of one or more embodiments of the present disclosure. The system 100 may include an input module 104 that may receive a plurality of live face images 102a of one or more users 101 captured by an image capturing device 102. Further, the input module 104 may also receive a plurality of audio files 103a of the one or more users 101 recorded by an audio recording device 103. The system 100 may further include a processor(s) 105 with a memory 106 for executing one or more module(s) 107, including but not limited to, a user face recognition module 108, an occlusion detection module 109, a user authentication module 110, and an audio analytics module 111. Additionally, the system 100 may include an object detection module 112 executed by the processor(s) 105. The processor(s) 105 may be further configured to control a warning module 114 of an output module 113. The warning module 114 may output a notification signal 114a to the one or more users 101 and an administrator 115.

In embodiments, the warning module 114 that may output a notification signal 114a to the one or more users 101 and the administrator 115 that may indicate that at least one suspicious activity 114b is determined during the secure online examination. Further, the suspicious activity 114b may be determined by the one or more modules(s) 107, including but not limited to, a user face recognition module 108, an occlusion detection module 109, a user authentication module 110, and an audio analytics module 111.

The processor(s) 105 may be implemented as one or more microprocessor(s), microcomputers, digital signal processor(s), central processing units, state machines, and/or any device that manipulates data based on operational instructions. Further, the processor(s) 105 may be configured to fetch and execute computer-readable instructions stored in a memory 106.

The system 100 may also include the memory 106. The memory 106 may be coupled to the processor(s) 105. The memory 106 may include any computer-readable medium, for example, volatile memory, such as Static Random Access Memory (SRAM), and Dynamic Random Access Memory (DRAM), and/or non-volatile memory, such as Read-Only Memory (ROM), flash memories, optic disks, and magnetic tapes.

Further, the memory 106 may include one or more module(s) 107. The module(s) 107 may be coupled to the processor(s) 105 and may include programs, objects, components, data structures, etc. which may perform tasks. The one or more module(s) 107 may also be implemented as, processor(s), state machine(s), logic circuitries, and/or any other device or component that manipulates signals based on operational instructions. Further, the memory 106 may store various notification signals 114a for the one or more module(s) 107 and may output at least one notification signal 114a on the detection of at least one suspicious activity 114b.

Further, the system 100 may be trained using CNN 116 The CNN 116 may be a multilayer network trained to perform a specific task using classification. The CNN 116 may perform segmentation, feature extraction, and classification with minimal pre-processing tasks on the plurality of live face images 102a. Further, the CNN 116 may process the plurality of audio files 103a by pre-processing them and later extracting the features of the plurality of audio files 103a to recognise the various types of speech (i.e., voice 111a), non-speech (i.e., silence 111b), and noise 111c elements present in the plurality of audio files 103a. The use of CNN 116 in the system 100 may reduce the memory requirements, and the number of parameters to be trained may be correspondingly reduced.

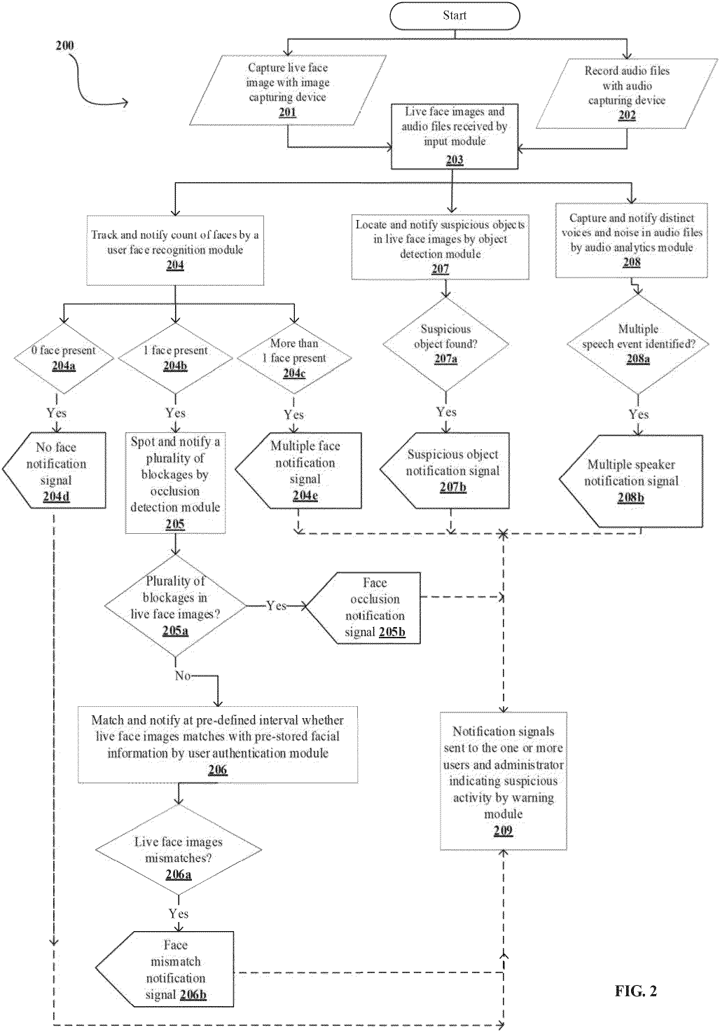

FIG. 2 is a simplified flow diagram 200 illustrating an end-to-end proctoring method based on CNN 116 for conducting a secure online examination. [0031] As illustrated in FIG. 2, the method 200 includes one or more blocks implemented by the system 100 for conducting the secure examination. The method 200 may be described in the general context of computer-executable instructions performed by the various processor(s) 105. Generally, a set of computer-executable instructions can include procedures, modules, and functions, which perform functions or implement abstract data types.

The order in which the method 200 is described, is not intended, to be construed as a limitation, and any number of the described method blocks can be combined in any order to implement the method 200. Further, the method 200 can be implemented in any suitable software, firmware, or combination thereof.

The method may start at step 201 with the capturing of the plurality of live face images 102a of the one or more users 101 by the image capturing device 102. The plurality of audio files 103a of the one or more users 101 may be recorded at step 202 by the audio capturing device 103. The plurality of live face images 102a and the plurality of audio files 103a are received by the input module 104 at step 203 for further processing. Further, the system 100 may include the processor(s) 105 with the memory 106 for executing one or more module(s) 107, including, but not limited to, the user face recognition module 108, the occlusion detection module 109, the user authentication module 110, and the audio analytics module 111. Additionally, the system 100 may include the object detection module 112 executed by the processor(s) 105.

At step 204, the user face recognition module 108 may track and notify the count of faces present in the plurality of live face images 102a of the one or more users 101 captured by the image capturing device 102. The user face recognition module 108 at step 204a may track a count of zero face present in the plurality of live face images 102a. Similarly, a count of one face at step 204b and a count of more than one face at step 204c present in the plurality of live face images 102a may be tracked by the user face recognition module 108. Furthermore, a “no face notification signal” 108a at step 204d and a “multiple face notification signal” 108b at step 204e may be outputted when the count of zero face at step 204a and more than one face at step 204c are tracked by the user face recognition module 108, respectively. Furthermore, the occlusion detection module 109 at step 205 may be configured to spot and notify the plurality of blockages 109a to the plurality of live face images 102a of the one or more user’s 101 face when the face count (equals to 1) is tracked by the user face recognition module 108 at step 204b.

At step 205a, the occlusion detection module 109 determines whether the plurality of blockages 109a is spotted in the plurality of live face images 102a of the one or more users 101. If the plurality of blockages 109a is spotted by the occlusion detection module 109 at step 205a (Yes), “a face occlusion notification signal” 109b may be outputted at step 205b. However, if the plurality of blockages 109a is not spotted by the occlusion detection module 109 at step 205a (No), the plurality of live face images 102a may be matched and notified by the user authentication module 110 at step 206. The user authentication module 110 at step 206 may be configured to match and notify at a pre-defined interval whether the live face images 102a of the one or more users 101 matches with the pre-stored facial feature information 110a of the one or more users 101 when at least one live face image 102a of the one or more user 101 is found to be non-occluded. If the plurality of live face images 102a of the one or more users 101 mismatches with the pre-stored facial feature information 110a of the one or more users 101 at step 206a (Yes), a “face mismatch notification signal” 110b may be outputted to the one or more users 101 and the administrator 115 by the user authentication module 110 at step 206b.

At step 207, the object detection module 112 may be configured to locate and notify a plurality of suspicious objects 112a present in the plurality of live face images 102a of the one or more users 101. If the plurality of suspicious objects 112a is located by the object detection module 112 at step 207a (Yes), a “suspicious object notification signal” 112b at step 207b may be outputted by the object detection module 112.

At step 208, the audio analytic module 111 may be configured to capture and notify a count of distinct voices 111a, silence 111b, and noise 111c present in the plurality of audio files 103a of the one or more users 101 recorded by the audio recording device 103 at step 202. The plurality of audio files 103a of the one or more users 101 may be captured by the audio analytics modules 111 at step 202 based on frequency, pitch, and tone characteristics of the one or more users 101 and may be received by the input module 104 at step 203. Further, if multiple speech events are identified by the audio analytics module 111 at step 208a, a multiple speaker notification signal 111c may be outputted at step 208b by the audio analytics module 111.

At step 209, the notification signals 114a may be outputted for the one or more module(s) 107 by the warning module 114 to the one or more users 101 and the administrator 115 indicating that at least one suspicious activity 114b may be determined by the system 100 during the secure online examination.

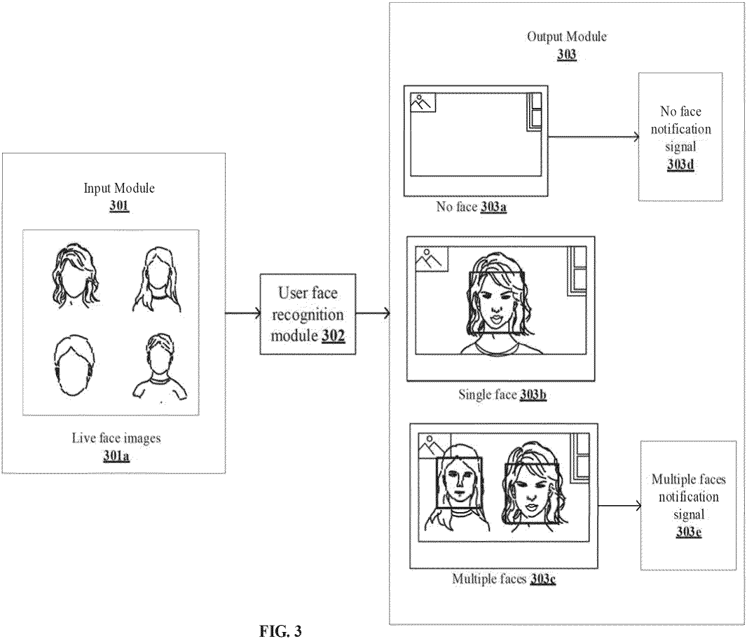

FIG. 3 illustrates a user face recognition module 302 utilised for tracking and notifying the count of faces present in a plurality of live face images 301a of the one or more users 101 received by an input module 301. As illustrated, the user face recognition module 302 may track the count of faces present in the plurality of live face images 301a of the one or more users 101 by utilising deep learning approaches. The user face recognition module 302 may perform pixelwise face localisation on various scales of the plurality of live face images 301a by using a joint extra-supervised and self-supervised multi-task learning.

In embodiments, the user face recognition module 302 may take the plurality of live face images 301a as an input from the input module 301 and may recognize the one or more facial area coordinates and some landmarks (eyes, nose, and mouth). Further, the user recognition module 302 may be trained to predict three pieces of information including identifying the presence or the absence of face in the plurality of live face images 301a, the presence of various landmarks denoting the location of the eyes, nose, and mouth, and a dense 3D mapping of the points of the plurality of live face images 301a to identify the one or more users 101. The user face recognition module 302 may employ one or more deep neural networks for extracting the features in the plurality of live face images 301a of the one or more users 101. Further, it may use a Fully Pyramidal Network (FPN) to produce a rich feature extraction of the plurality of live face images 301a. The FPN may allow the user face recognition module 302 to make use of both the high-level and low-level features, which may assist in detecting small faces in the plurality of live face images 301a. Further, the user face recognition module 302 on a single-shot may learn three information, i.e., a no face found 303a, a single face found 303b, and a multiple faces found 303c in the plurality of live face images 301a of the one or more users 101. Furthermore, the user face recognition module 302 may include an output module 303 that may output the “no face notification signal” 303d when the no face 303a is tracked and may output the “multiple face notification signal” 303e to the one or more users 101 and the administrator 115 when the multiple faces 303c is tracked in the plurality of live face images 301a of the one or more users 101.

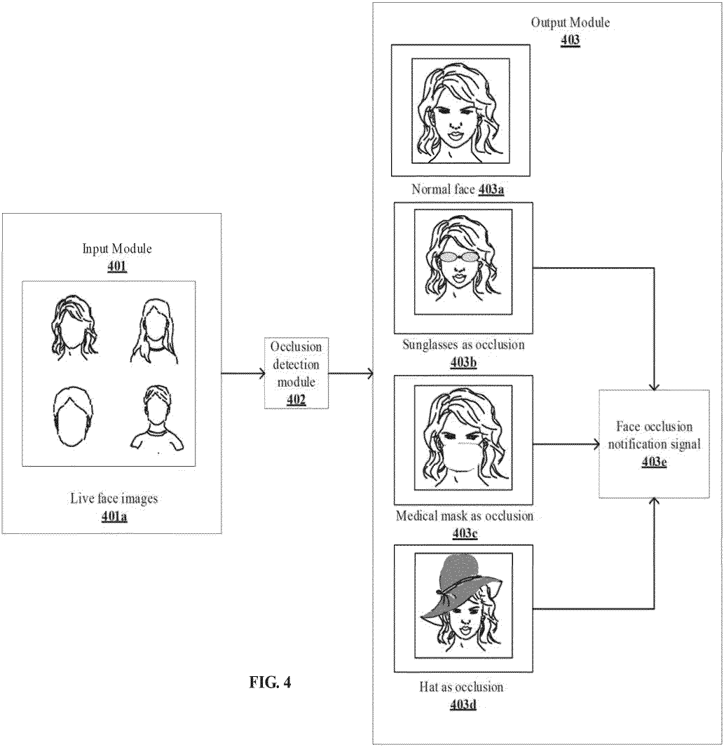

FIG. 4 illustrates an occlusion detection module 402 utilised for spotting and notifying the plurality of blockages 109a to plurality of live face images 401a of the one or more user’s 101 face received by an input module 401. As illustrated, the occlusion detection module 402 may spot the plurality of blockages 109a including, but not limited to, facial accessories like sunglasses 403b, medical masks 403c and hats/caps 403d to the plurality of live face images 401a of the one or more user’s 101 face when the face count (equals to 1) (i.e., single face 303b) is tracked by the user face recognition module in 302 in FIG. 3. Further, for spotting the plurality of blockages 109a, a multi-label classification approach may be used that may deploy a Caltech Occluded Face in the Wild (COFW) dataset. The dataset may assign labels to six classes, i.e., full face, left eye, right eye, nose, mouth, and chin to each of the plurality of live face images 401a. Further, a CNN 116 based architecture may be applied to the COFW dataset that may train the occlusion detection module 402. The CNN 116 based architecture may extract and detect the features of the plurality of live face images 401a during training, validation, and testing phases. The CNN 116 based architecture during the training, validating, and testing phase may use two types of the dataset, i.e., one with the plurality of face images 401a having the plurality of blockages 109a (as illustrated in 403b, 403c, and 403d), and another without the plurality of blockages 109a having a normal face 403a. Further, a transfer learning with the CNN 116 based architecture is applied that may be used to recognise the plurality of live face images 402a with (as illustrated in 403b, 403c, and 403d) or without (as illustrated in 403a) the plurality of blockages 109a. The occlusion detection module 402 may be trained over a COFW dataset of approximately 1000 live face images 402a, to achieve 99 percent of precision accuracy of the occlusion detection module 402. Moreover, the training of the occlusion detection module 402 using the COFW dataset and CNN 116 based architecture may ensure improved accuracy and lesser training time.

Furthermore, the occlusion detection module 402 may include an output module 403 that may output a “face occlusion notification signal” 403e to the one or more users 101 and the administrator 115 when the plurality of blockages 109a may be spotted by the occlusion detection module 402 in the plurality of live face images 401a of the one or more user’s 101 face.

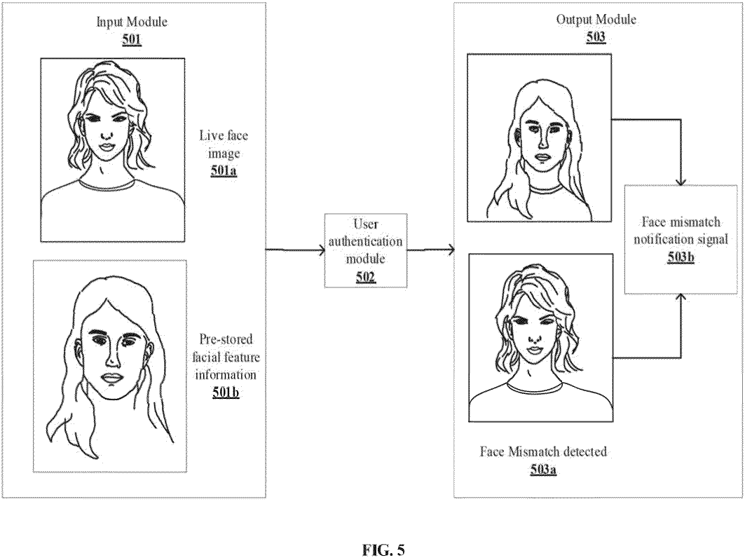

FIG. 5 illustrates a user authentication module 502 utilised for matching and notifying at a pre-defined interval whether the plurality of live face images 501a of the one or more users 101 received by the input module 501 matches with a pre-stored facial feature information 501b of the one or more users 101 when non-occluded live face image 501a (Normal face 403a) of the one or more users 101 is spotted by the occlusion detection module 402 in FIG. 4. The facial feature information 110a of the one or more users 101 may be stored in the user face authentication database/memory storage 502a. The user face authentication database 502a may contain the identity of the one or more users 101 collected before the commencement of the secure online examination. Further, the user authentication module 502 may utilise a machine learning-based algorithm that may take the plurality of live face images 501a and the pre-stored facial feature information 501b as an input and may output the distance between the plurality of live face images 501a and the pre-stored facial feature information 501b to detect the likelihood of the same one or more users 101. The machine learning-based algorithm may be initially trained to extract appropriate embeddings from the plurality of live face images 501a and the pre-stored facial feature information 501b of the one or more users 101. Further, the embeddings of the plurality of live face images 501a and the pre-stored facial feature information 501b of the one or more users 101 may be created by creating a squared distance between the plurality of live face images 501a, regardless of any imaging conditions (low or high pixels). The machine learning-based algorithm may use a similarity learning mechanism that may calculate the distance between the embeddings of the plurality of live face images 501a and the pre-stored facial feature information 501b using a cosine distance. The cosine distance may measure the similarity between the embeddings and may be used to check if the distance between the embeddings of the plurality of live face images 501a and the pre-stored facial feature information 501b exceeds a predefined threshold. The predefined threshold may be set by using decision tree algorithms that may find the best split point of the predefined threshold. Additionally, the user authentication module 502 may be trained to match and notify the plurality of live face images 501a of the one or more user 101 with the pre-stored facial feature information 501b at a pre-defined interval. The pre-defined interval may be set to, for example, 5 milliseconds, or 10 milliseconds. After the completion of the pre-defined interval (such as 5 milliseconds), the user authentication module 502 may match and notify whether the plurality of live face images 501a matches with the pre-stored facial feature information 501b of the one or more users 101.

Further, if the distance between the embeddings of the plurality of live face images 501a and the pre-stored facial feature information 501b of the one or more users 101 is found to be less than a particular threshold, the user authentication module 502 may output a face mismatch 503a information to an output module 503. The output module 503 may further output a “face mismatch notification signal” 503b to the one or more users 101 and the administrator 115.

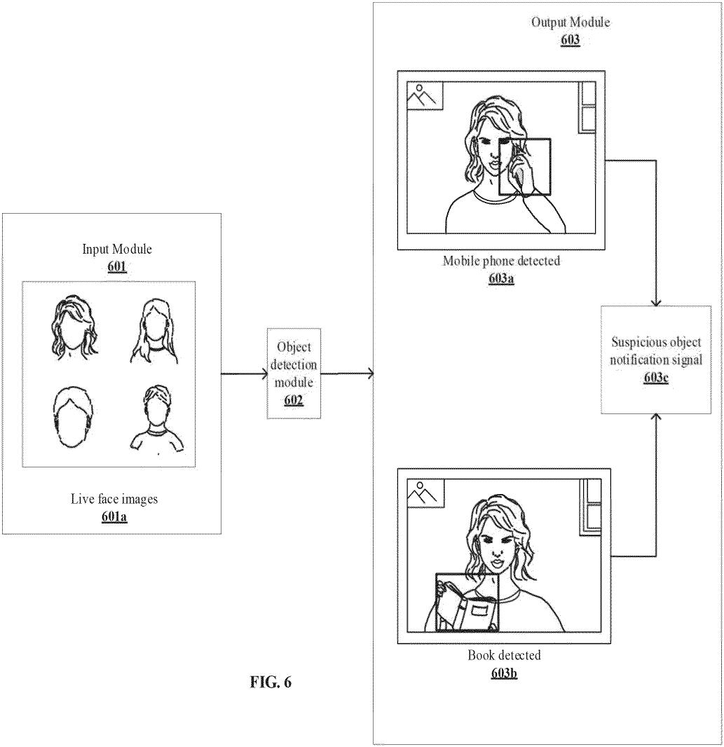

FIG. 6 illustrates an object detection module 602 utilised for locating and notifying the plurality of suspicious objects 112a present in a plurality of live face images 601a of the one or more users 101 received by an input module 601. As illustrated, the object detection module 602 may locate the plurality of suspicious objects 112a including, but not limited to, mobile phones and/or handheld device displaying content 603a, and books 603b in the plurality of live face images 601a of the one or more users 101.

Further, for locating the plurality of suspicious objects 112a, an object detection algorithm 116-1(n) based on the CNN 116 may be utilised. The object detection algorithm 116-1(n) based may be a single-stage algorithm that may be formed mainly of the convolutional layers to train the object detection module 602. The object detection module 602 may recognise the plurality of suspicious objects 112a present in a single frame of the plurality of live face images 602a. The plurality of suspicious objects 112a may be recognised by the object detection module 602 from the plurality of live face images 602a by making a boundary around the plurality of suspicious objects 112a.

In an embodiment, the object detection module 602 may take the plurality of live face images 602a as the input from the input module 601. Further, feature extraction of the plurality of live face images 601a may be performed by a pre-trained network based on the CNN 116. Furthermore, the CNN 116 may add one or more convolutional layers to interpret the plurality of live face images 602a as the bounding boxes and classes of the plurality of suspicious objects 112a. The object detection algorithm 116-1(n) based on the CNN 116 may further increase the robustness by collecting the features extracted by the one or more computational layers of the CNN 116. The object detection module 602 may thereby locate the plurality of the suspicious objects 112a including, but not limited to, mobile phone 603a and book 603b, by utilising the object detection algorithm 116-1(n) and may output it to an output module 603. The output module 603 may further output a “suspicious object notification signal” 603c to the one or more user 101 and the administrator 115 when the plurality of suspicious objects 112a is detected by the object detection module 602.

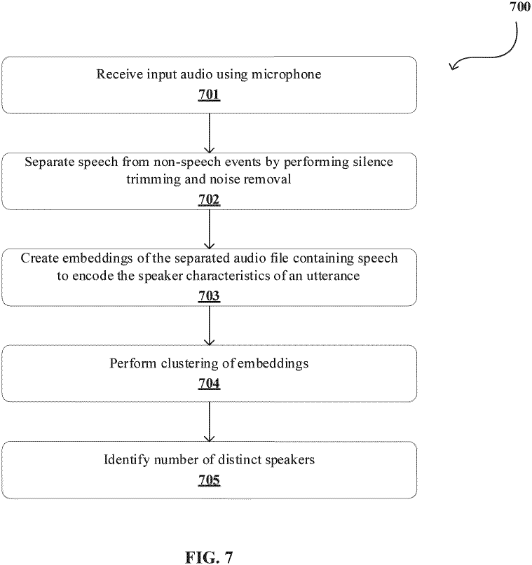

FIG. 7 illustrates a process flow 700 for capturing and notifying the count of distinct voices 111a, silence 111b and noise 111c present in the plurality of audio files 103a of the one or more users 101 based on frequency, pitch, and tone characteristics of the one or more users 101. At step 701, the plurality of audio files 103a may be recorded by the audio recording device 103. The audio recording device 103, in an embodiment, may be a microphone, or a recorder, recording the plurality of audio files 103a of the one or more users 101.

At step 702, the speech events i.e., the voice 111a, the non-speech event including silence 111b and the noise 111c may be separated by preprocessing them. The plurality of audio files 103a may be initially pre-processed to remove the background silence 111b and the noise 111c and may be again pre-processed to remove more noise 111c from the plurality of audio files 103a.

At step 703, the embeddings of the speech event i.e., the voice 111a may be generated to encode the one or more users 101 characteristics of an utterance into a fixed-length vector. For generating the embeddings of the voice 111a, a deep learning algorithm may be used to generate a high-level representation of the voice 111a. The deep learning algorithm may further create a summary vector of 256 values of the voice 111a that may summarize the characteristics of the voice 111a spoken by the one or more users 101. The embeddings may be a vector representation of the voice 111a which may be used by the deep learning algorithm.

At step 704, the clusters of the embeddings may be created of the speech events, i.e., the voice 111a based on the frequency, pitch, and tone characteristics of the one or more users 101. While clustering, the embeddings of the segments belonging to the same user’s 101 voice 111a may be labelled into one cluster, and the embeddings of the segments belonging to some other user 101 may be labelled into another cluster. The number of clusters created from the embeddings of the voice 111a may conclude the count of distinct voices 111a present in the plurality of audio files 103a of the one or more users 101.

At step 705, the “multiple speaker notification signal” 208b may be outputted by the audio analytics module 111 to the one or more users 101 and the administrator 115 when more than one count of distinct voices 111a present in the plurality of audio files 103a of the one or more users 101 is captured by the audio analytics module 111 indicating at least one suspicious activity 114b may be determined by the audio analytics module 111.

The training of the system 100 having the processor(s) 105 with the memory 106 for executing one or more module(s) 107 may be performed by utilising various deep learning approaches such as CNN 116. CNN 116 may leverage over a very large dataset of the plurality of live face images 102a and may learn rich and compact representations of faces, allowing one or more module(s) 107 to first perform as well and later to outperform the recognition capabilities. Additionally, the use of deep learning approaches such as CNN 116 has proven to be effective in image recognition and classification tasks. Furthermore, CNN 116 along with Recurrent Neural Network (RNN) may be utilised to perform the identification of the one or more users 101 present in the plurality of audio files 103a by performing the feature learning and classification in the plurality of audio files 103a.

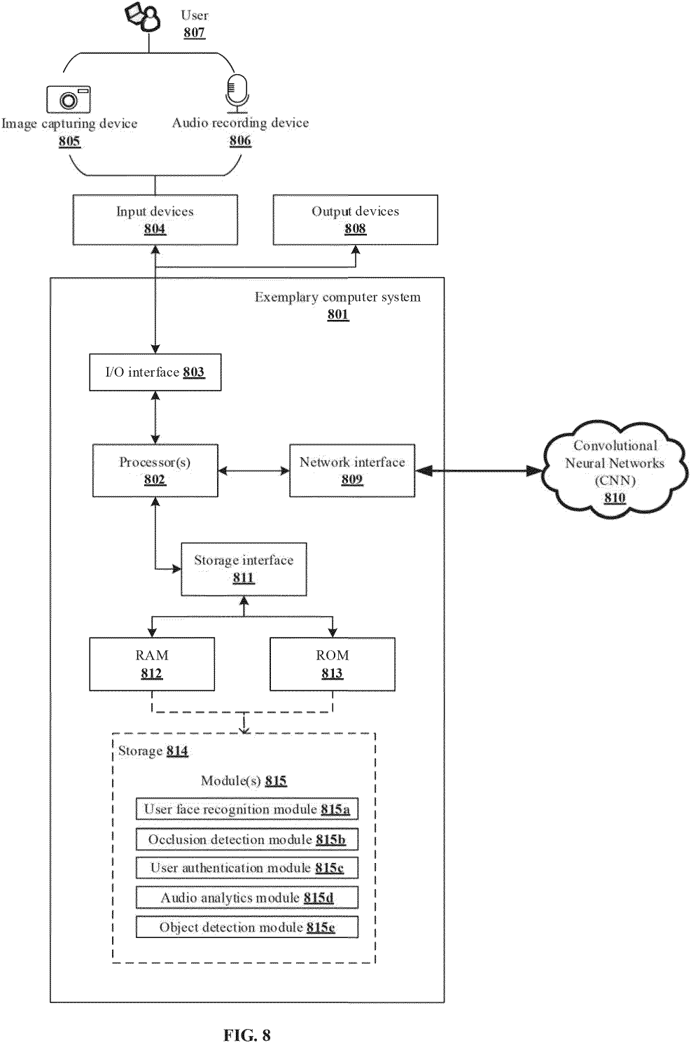

FIG. 8 illustrates a block diagram of an exemplary computer system 801 for implementing embodiments consistent with the present disclosure.

In an embodiment, the computer system 801 may be the end-to-end proctoring system 100 for conducting the secure online examination. The computer system 801 may include a central processing unit (“CPU” or “processor”) 802 The processor 802 may include processing units such as integrated system (bus) controllers, memory management control units, floating units, digital signal processing units, etc.

The processor 802 may be in communication with one or more input devices 804 namely an image capturing device 805, an audio recording device 806, along with one or more users 807 via I/O interface 803. The processor 802 may be in communication with the output devices 808 via I/O interface 803. The I/O interface 803 may employ communication protocols/methods such as, without limitation, audio, analog, digital, stereo, IEEE-1394, serial bus, Universal Serial Bus (USB), Radio Frequency (RF) antennas, S-Video, Video Graphics Array (VGA), IEEE 802.n /b/g/n/x, Bluetooth, cellular (e.g., Code-Division Multiple Access (CDMA), High-Speed Packet Access (HSPA+), Global System for Mobile Communications (GSM), Long-Term Evolution (LTE) or the like), etc. Using the network server 809, the computer system 801 may be connected to the Convolutional Neural Network (CNN) 810.

In some embodiments, the processor 802 may be disposed in communication with a storage 814 e.g., RAM 812, and ROM 813, etc., via a storage interface 811. The storage interface 811 may connect to storage 814 including, but not limited to, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The storage 814 may store a collection of one or more module(s) 815, including, but not limited to, a user face recognition module 815a, an occlusion detection module 815b, a user authentication module 815c, an audio analytics module 815d, and an object detection module 815e.

Thus, the end-to-end proctoring system and method based on CNN for conducting a secure online examination have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

As described above, the module(s), amongst other things, include routines, programs, objects, components, and data structures, which perform particular tasks or implement particular abstract data types. The module(s) may also be implemented as, signal processor(s), state machine(s), logic circuitries, and/or any other device or component that manipulate signals based on operational instructions. Further, the modules can be implemented by one or more hardware components, by computer-readable instructions executed by a processing unit(s), or by a combination thereof.

It is intended that the disclosure and examples be considered as exemplary only, with a true scope of disclosed embodiments being indicated by the following claims.

1. An end-to-end proctoring system for conducting a secure online examination including:
an image capturing device for capturing a plurality of live face images of one or more users;
an audio recording device for recording a plurality of audio files of one or more users;
a processor for executing one or more modules stored in a memory, wherein the one or more modules includes:
a user face recognition module, configured to dynamically track and notify a count of faces present in the plurality of live face images of the one or more users;
an occlusion detection module, configured to spot and notify a plurality of blockages to the plurality of live face images of the one or more user’s face when the face count is tracked by the user face recognition module;
a user authentication module, configured to match and notify at a pre-defined interval whether the plurality of live face images of the one or more users matches with a pre-stored facial feature information of the one or more users when a non-occluded live face image of at least one user is spotted by the occlusion detection module;
an audio analytics module, configured to capture and notify a count of distinct voices and noise present in the plurality of audio files of the one or more users based on frequency, pitch, and tone characteristics of the one or more users, wherein the processor is configured to control a warning module;
wherein the warning module may output a notification signal for the one or more modules including, but not limited to, the user face recognition module, the occlusion detection module, the user authentication module, and the audio analytics module to the one or more users and an administrator,
wherein, the notification signal indicating that at least one suspicious activity is determined during the secure online examination.

2. The system according to claim 1 further includes an object detection module, configured to locate, and notify a plurality of suspicious objects present in the plurality of live face images of the one or more users, wherein the plurality of suspicious objects, including, but not limited to, books and mobile phones.

3. The system according to claim 1, wherein the system with the processor for executing the one or more modules is pre-trained based on various deep learning-based approaches, configured to determine the at least one suspicious activity during the secure online examination.

4. The system according to claim 1 further includes a webcam coupled to the system, wherein the webcam is programmed to capture the plurality of live face images of the one or more users during the secure online examination.

5. The system according to claim 1 further includes a microphone coupled to the system, wherein the microphone is programmed to record the plurality of audio files of the one or more users during the secure online examination.

6. The system according to claim 1, wherein the one or more modules are further programmed to automatically analyze the plurality of the live face images and the plurality of the audio files of the one or more users to provide the notification signal to the one or more users and the administrator if the evidence of the at least one suspicious activity is determined.

7. An end-to-end proctoring method for conducting a secure online examination including:
capturing a plurality of live face images of one or more users by an image capturing device;
recording a plurality of audio files of one or more users by an audio recording device;
executing one or more modules stored in a memory by a processor, wherein the one or more modules includes:
dynamically tracking and notifying a count of faces present in the plurality of live face images of the one or more users by a user face recognition module wherein,
if the face count is tracked by the user face recognition module, spotting, and notifying a plurality of blockages to the plurality of live face images of the one or more user’s face by an occlusion detection module;
if a non-occluded live face image of at least one user is spotted by the occlusion detection module, matching, and notifying at a pre-defined interval whether the plurality of live face images of the one or more users matches with a pre-stored facial feature information of the one or more users by a user authentication module; further
capturing and notifying a count of distinct voices and noise present in the plurality of audio files of the one or more users based on frequency, pitch, and tone characteristics of the one or more users by an audio analytics module; wherein the processor is configured to control a warning module;
wherein a notification signal for the one or more modules including, but not limited to, the user face recognition module, the occlusion detection module, the user authentication module, and the audio analytics module is outputted to the one or more users and an administrator by the warning module,
wherein, the notification signal indicating that at least one suspicious activity is determined during the secure online examination.

8. The method according to claim 7 further includes an object detection module, configured to locate, and notify a plurality of suspicious objects present in the plurality of live face images of the one or more users by an object detection algorithm that can recognise multiple suspicious objects in the plurality of live face images.

9. The method according to claim 7, wherein the object detection module is further configured to locate the plurality of suspicious objects, including, but not limited to, books, and mobile phones in the plurality of live face images of the one or more users; and
output a suspicious object notification signal when the plurality of suspicious objects is located in the plurality of live face images of the one or more users.

10. The method according to claim 7, wherein the user face recognition module is configured to dynamically track the count of faces present in the plurality of live face images of the one or more users by localizing and finding coordinates of a facial area such as eye, nose, and mouth coordinates.

11. The method according to claim 7, wherein the user face recognition module is further configured to output a notification signal to the one or more users and the administrator, wherein the notification signal includes:
a multiple face notification signal when the count of faces present in the plurality of live face images of the one or more users is greater than one; and
a no face notification signal when the count of faces present in the plurality of live face images of the one or more users is equal to zero.

12. The method according to claim 7, wherein the occlusion detection module is configured to spot the plurality of blockages in the plurality of live face images of the one or more users face by performing a multi-label classification, wherein the multi-label classification assigns labels to a full-face, left eye, right eye, nose, mouth, and chin to spot the plurality of blockages in the plurality of live face images of the one or more user’s face.

13. The method according to claim 7, wherein the occlusion detection module is further configured to spot the plurality of blockages, including, but not limited to, facial accessories, hats, or medical masks in the plurality of live face images of the one or more user’s face; and
output a face occlusion notification signal when the plurality of blockages in the plurality of live face images of the one or more user’s faces is spotted.

14. The method according to claim 7, wherein the user authentication module is configured to match the non-occluded faces of the one or more users in the plurality of live face images with the pre-stored facial feature information of the one or more users by calculating and comparing an embedding of the plurality of live face images with an embedding of the pre-stored facial feature information of the one or more users.

15. The method according to claim 7, wherein the user authentication module is further configured to output a face mismatch notification signal when the comparison of the embeddings of the plurality of live face images and the pre-stored facial feature information of the one or more users is found to be less than a particular threshold.

16. The method according to claim 7, wherein the count of distinct voices and noise present in the plurality of audio files of the one or more users is captured by the audio analytics module, includes:
separating speech, non-speech, and noise events of the one or more users in the plurality of audio files by preprocessing the plurality of audio files to remove a background silence and the noise and again preprocessing to remove more noise from the plurality of audio files;
generating an embedding of a speech event of the one or more users in the plurality of audio files to encode the one or more user’s voice characteristics of an utterance into a fixed-length vector; and
creating clusters of the embeddings of the speech events of the one or more users based on the frequency, pitch, and tone characteristics by using an unsupervised online clustering algorithm.

17. The method according to claim 7, wherein the audio analytics module is configured to output a multiple speaker notification signal when a multiple speech event is identified in the plurality of audio files of the one or more users.
